(19) United States
(12) Patent Application Publication
(10) Pub. No.: US 2022/0288757 A1
(43) Pub. Date: Sep. 15, 2022

(54) DRONE GLASS BREAKER

(71) Applicant: Blake Resnick, Las Vegas, NV (US)

(72) Inventor: Blake Resnick, Las Vegas, NV (US)

(21) Appl. No.: 17/197,021

(22) Filed: Mar. 9, 2021

(51) Int. Cl. B25D 11/02; B64C 39/02

(52) U.S. Cl. CPC B25D 11/02; B64C 39/024; B64C 2201/128; B25D 2250/271

(57) ABSTRACT

An unmanned aerial vehicle (UAV) includes a UAV frame; and a propulsion system coupled to the UAV frame and configured to cause the vehicle to be airborne. The UAV also includes a control system configured to control the flight of the vehicle and a glass breaker coupled to the UAV frame.

### TECHNICAL FIELD

The present disclosure relates to systems for breaking glass with autonomous security vehicles including drones.

### BACKGROUND

Unmanned Aerial Vehicles (UAVs, commonly known as drones) generally originated in military applications. Today their use has proliferated to many more applications including aerial photography, product deliveries, agriculture, policing and surveillance, infrastructure inspections, science, racing, etc. Ground based robots and remote-controlled vehicles have also been used in policing and security applications. Conventionally, in policing applications it may become necessary for a robot to forcibly enter a building or other structure. Such robots have been known to use rams or ramming motions in order to break through a door, wall, or window.

### SUMMARY

Various disclosed embodiments include cover assemblies for an electrical busbar connection, busbar connector assemblies, and battery systems.

In some embodiments, an unmanned aerial vehicle (UAV) includes a UAV frame; and a propulsion system coupled to the UAV frame and configured to cause the vehicle to be airborne. The UAV also includes a control system configured to control the flight of the vehicle and a glass breaker coupled to the UAV frame.

In other embodiments, an unmanned vehicle includes a frame, a propulsion system coupled to the frame and configured to cause the vehicle to move, and a control system configured to control the movement of the vehicle, and a glass breaker coupled to the frame.

In yet other embodiments, a method of breaking a glass pane includes causing a drone aircraft to fly in front of the glass pane and starting a motor which rotates a rotary glass breaking structure on the end of a boom coupled to the drone aircraft. The method also includes causing the drone aircraft to contact the rotating rotary glass breaking structure with the glass pane and causing the drone aircraft to withdraw away from the glass pane.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is an illustrative perspective view of a drone aircraft approaching a window.

FIG. 2 is an illustrative perspective view of a drone aircraft contacting the window of FIG. 1 with a glass breaker.

FIG. 3 is an illustrative perspective view of a drone aircraft contacting the window of FIG. 1 with a glass breaker.

FIG. 4 is an illustrative perspective view of a drone aircraft contacting the window of FIG. 1 with a glass breaker.

FIG. 5 is an illustrative underside perspective view of the glass breaker structure attached to the drone aircraft.

FIG. 6 is an illustrative perspective view of the glass breaker as an attachable component for a drone aircraft.

FIG. 7 is an illustrative exploded perspective view of the glass breaker of FIG. 6.

FIG. 8 is an illustrative exploded closeup perspective view of the rotary glass breaker with end effectors. of FIG. 6.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

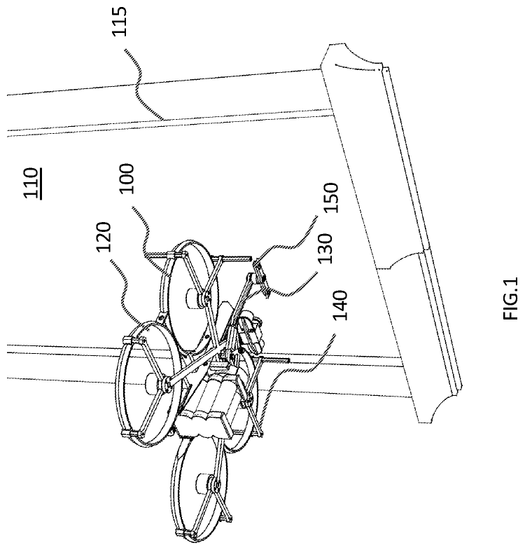

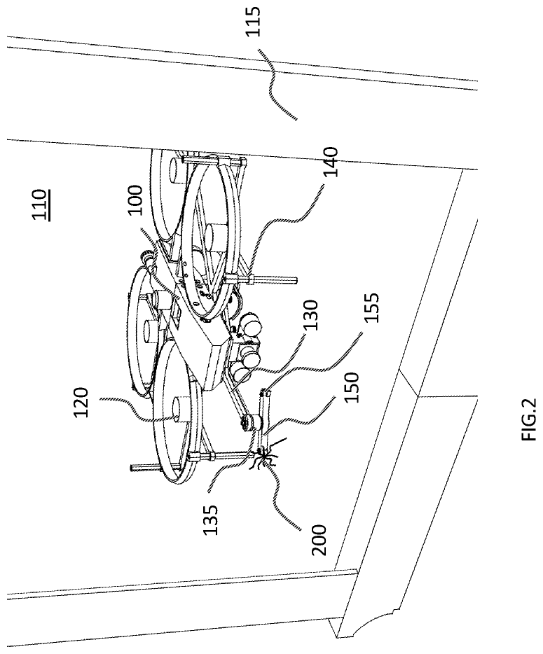

Referring now to FIGS. 1 and 2, a drone aircraft (or unmanned aerial vehicle (UAV)) 100 is depicted flying in front of a glass pane, depicted as glass pane 110 of window 115. Drone aircraft 100 is depicted as a quadcopter having four driven propellers 120 which may be independently driven to control the movement of drone aircraft 100. Drone aircraft 100 is not limited to a quadcopter but may be any type of UAV or alternatively any type of ground-based robot or ground based remote controlled vehicle. Drone aircraft 100 also includes an arm or boom 130 coupled to a frame 140 of the drone aircraft 100. Boom 130 supports a rotary glass breaker 150 that is spun (rotated) at high speed by an electric motor 135. In an illustrative embodiment, rotary glass breaker 150 may be spun at any of a variety of speeds depending on the type of glass to be broken and the material and geometry of end effectors 155 attached to rotary glass breaker 150. For example, it may be beneficial to rotate the rotary glass breaker 150 at 5000 revolutions per minute (RPM) or alternatively 10,000 to 15,000 RPMs or more.

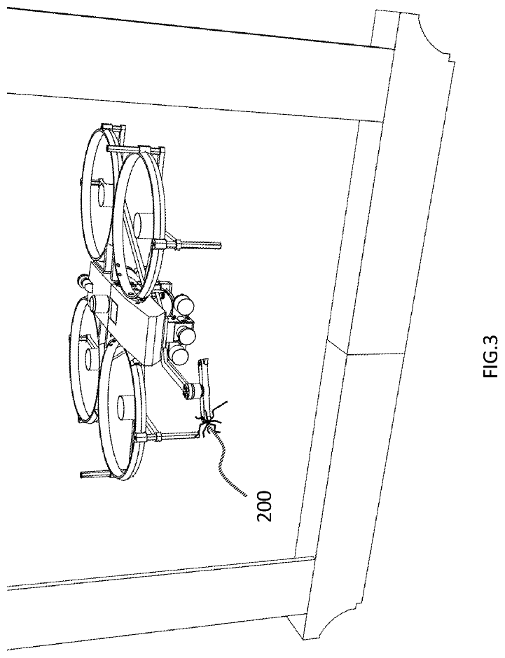

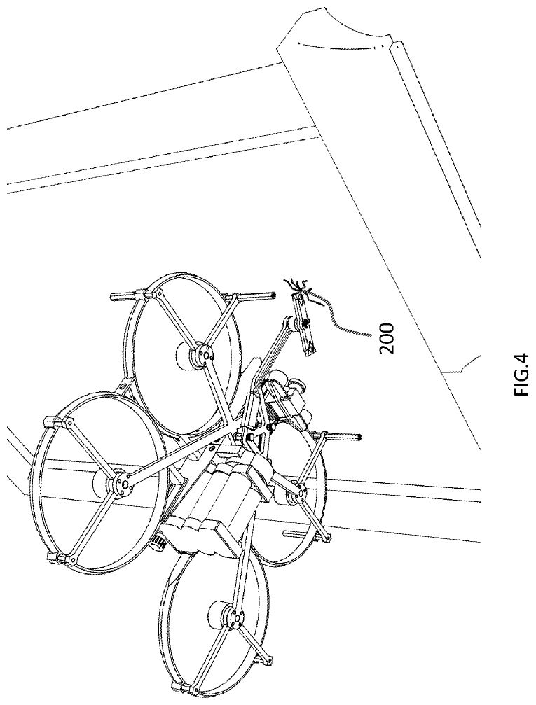

In accordance with an illustrative embodiment when it is needed for a glass pane to be broken, for example in a policing action where forced entry is necessitated, drone aircraft 100 is controlled to fly in front of the glass pane. In some examples, the UAV may be controlled to fly near the top of the glass pane such that when the glass breaks most of the glass will not hit the UAV potentially causing damage to the UAV. As UAV 100 approaches glass pane 110 the motor 135 is started to rotate the rotary glass breaker 150 on the end of the boom 130 coupled to the drone aircraft 100. The UAV is then controlled to cause the drone aircraft to contact the rotating rotary glass breaker with the glass pane at a point 200 as depicted in FIGS. 2, 3, and 4. As contact occurs, the glass panel breaks and simultaneously the drone aircraft withdraws away from the glass panel to attempt to avoid being hit by broken glass pieces.

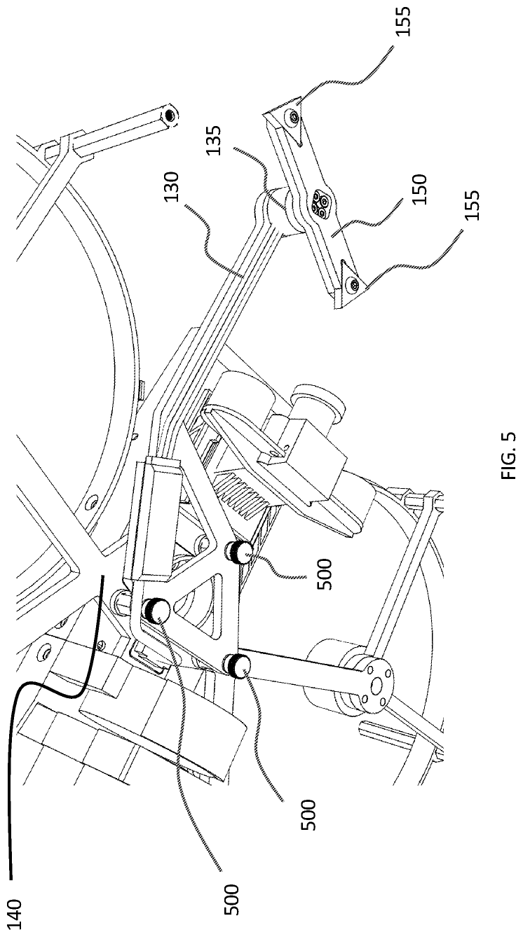

Referring now to FIG. 5, frame 140 is configured to support arm 130. In an illustrative embodiment, arm 130 may be formed from any of a variety of high strength materials including but not limited to 7075 aluminum, Kevlar, or carbon graphite composites, that is any materials which exhibit considerable strength are formed to absorb energy. Similarly, rotatory glass breaker 150 may be made from similar materials. In an illustrative embodiment, rotary glass breaker 150 may be formed with a geometry to engage with end effectors 155 to help absorb energy. In this instance rotary glass breaker 150 may have a triangular indent 157 to match the geometry of end effector 155. In an illustrative embodiment, arm 130 may be bolted or screwed to frame 140 by one or more fasteners such as but not limited to bolts 500. In some illustrative embodiments, there may be three or more blots used so that each of the three or more bolts carries some of the load that is imparted on the frame 140 when contact with glass pane 110 is made with glass breaker 150.

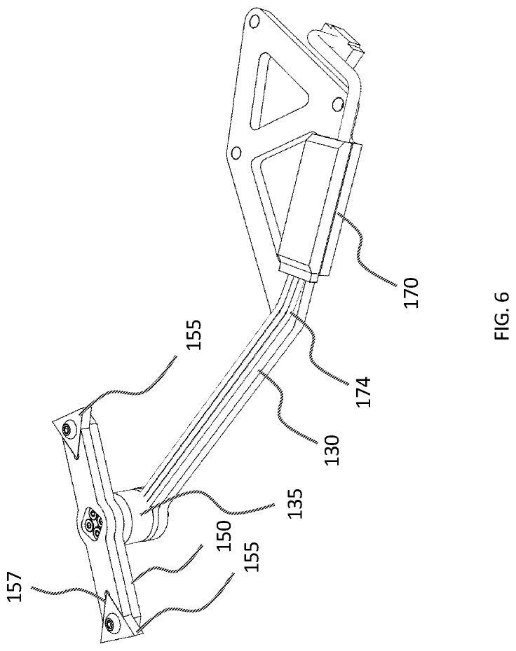

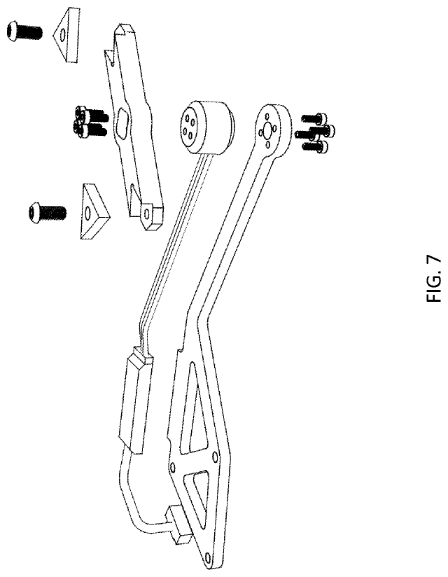

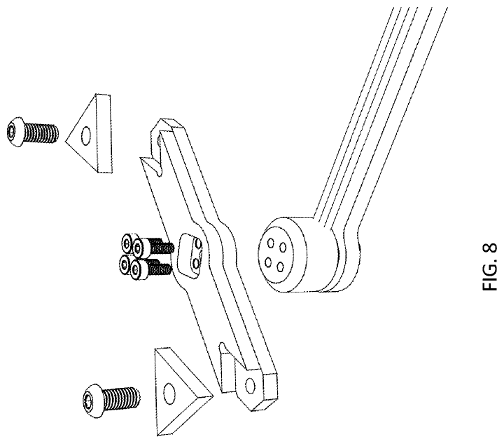

Referring to FIGS. 6 and 7, a motor controller 170 is coupled to motor 135 via a wiring harness 174. Motor controller 170 is further coupled to the drone CPU and to the drone's power source or another pour source through a connector 176. As depicted in FIGS. 7 and 8 arm 130 includes rotary glass breaker 150 with end effectors 155. In accordance with an illustrative embodiment, end effectors 155 may be in the form of a variety of geometries including a triangle as depicted, but other shapes may be equally or more effective including but not limited to diamond shape or star shape, etc., shapes that may have pointed tips for impacting the glass surface. In accordance with an illustrative embodiment, motor 135 may be coupled to arm 130 with one or more screws or fasteners including but not limited to the screws or bolts 137. As depicted in FIG. 8, rotary glass breaker 150 may similarly be coupled to motor 135 by screws 139, bolts, or the like. It may be advantageous to use multiple screws in order to distribute some of the load among them. For example, as depicted rotary glass breaker 150 is attached to motor 135 by four screws. It should be noted that any number of screws or other fasteners may be used without departing from the scope of the described subject matter. End effectors 155 may be coupled to rotary glass breaker 100 with a single screw as depicted in FIG. 8. End effectors 155 may be supported by multiple fasteners or may, as depicted, be supported by a single screw or fastener and by the geometry of the rotary glass breaker 150, which has geometry configured to engage with one or more sides of the end effectors 155.

In accordance with illustrative embodiments, sensors may be supported on frame 140, such as but not limited to camera 180 as well as other types of sensors e.g., radar, lidar, infrared, ultrasonic, acoustic, etc. Sensors 180 may help determine the properties of the glass and help dictate controlling UAV 100 to break the glass pane 110.

In accordance with illustrative embodiments, the glass breaker may be a component that is attachable to a drone, a robot, a manned vehicle, an exoskeleton, etc. Accordingly, the glass breaker may include a support structure like arm 130 that includes structure for attaching to another structure, e.g., screws or bolts 500. The glass breaker further includes a motor and a structure to provide power to the motor, which may be via wiring to the vehicles power or through a battery coupled to the arm 130. Such an attachable component may be made to attach to a variety of structures or to a variety of aircraft.

The mechanical construction shown and described may be varied without departing from the scope of the invention as clearly defined by the claims.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. An unmanned aerial vehicle (UAV), comprising:
a UAV frame.
a propulsion system coupled to the UAV frame and configured to cause the vehicle to be airborne;
a control system configured to control the flight of the vehicle; and
a glass breaker coupled to the UAV frame.

2. The UAV of claim 1, wherein the glass breaker includes an arm extending from the frame.

3. The UAV of claim 1, wherein the glass breaker includes a rotary glass breaking element.

4. The UAV of claim 3, wherein the glass breaker includes a motor coupled to the rotary glass breaking element.

5. The UAV of claim 4, wherein the rotary glass breaking element includes a glass breaking tip at at least one end and the glass breaking tip being formed of a different material than the rotary glass breaking element.

6. The UAV of claim 5, wherein the glass breaking tip includes pointed edges.

7. The UAV of claim 5, wherein the glass breaking tip comprises at least one of tungsten carbide, tool steel, ceramic, metal carbide, industrial diamond.

8. The UAV of claim 3, wherein the motor is configured to spin the rotary glass breaking element at at least 5000 rpm.

9. The UAV of claim 3, wherein the motor is configured to spin the rotary glass breaking element at at least 10000 rpm.

10. The UAV of claim 3, wherein a speed of the motor is configured to be controlled.

11. The UAV of claim 3, wherein a speed of the motor is configured to be controlled based on the output of one or more sensors coupled to the UAV frame.

12. An unmanned vehicle, comprising:
a frame;
a propulsion system coupled to the frame and configured to cause the vehicle to move;
a control system configured to control the movement of the vehicle; and
a glass breaker coupled to the frame.

13. The unmanned vehicle of claim 12, wherein the glass breaker includes an arm extending from the frame with a rotary glass breaking element.

14. The unmanned vehicle of claim 13, wherein the glass breaker includes a motor coupled to the rotary glass breaking element.

15. The unmanned vehicle of claim 14, wherein the rotary glass breaking element includes a glass breaking tip at at least one end and the glass breaking tip being formed of a different material than the rotary glass breaking element.

16. The unmanned vehicle of claim 15, wherein the glass breaking tip includes pointed edges.

17. The unmanned vehicle of claim 15, wherein the glass breaking tip comprises at least one of tungsten carbide, tool steel, ceramic, metal carbide, industrial diamond.

18. The unmanned vehicle of claim 14, wherein a speed of the motor is configured to be controlled.

19. The unmanned vehicle of claim 14, wherein a speed of the motor is configured to be controlled based on the output of one or more sensors coupled to the frame.

20. A method of breaking a glass pane, comprising:
causing a drone aircraft to fly in front of the glass pane;
starting a motor which rotates a rotary glass breaking structure on the end of a boom coupled to the drone aircraft;
causing the drone aircraft to contact the rotating rotary glass breaking structure with the glass pane; and
causing the drone aircraft to withdraw away from the glass pane.
